(19) United States
(12) Patent Application Publication
(10) Pub. No.: US 2006/0248801 A1
(43) Pub. Date: Nov. 9, 2006

(54) Pivoting arch frame

(75) Inventor: Mario Marocco, Woodbridge (CA)

Correspondence Address: MILLER THOMPSON, LLP, Scotia Plaza, 40 King Street West, Suite 5800, TORONTO, ON, M5H 3S1, CA

(73) Assignee: Shade-O-Matic Limited

(21) Appl. No.: 11/123,051

(22) Filed: May 6, 2005

(51) Int. Cl. E06B 7/08

(52) U.S. Cl. 49/74.1

(57) ABSTRACT

A covering formed for an arched window comprising at least one slat having two opposite ends connected to said arched window for pivotable rotational movement thereabouts

### FIELD OF INVENTION

This invention relates to a covering for an arched window having at least one slat connected to said arched window for pivotable rotational movement thereabouts, and particularly relates to a shutter having a plurality of slats pivotally moveable at the edges of the transverse ends to open and substantially close and arched opening and particularly the bottom edge of the transverse ends. The invention also relates to the method of opening and closing an arched opening with a plurality of slats and to the arched frame.

### BACKGROUND TO THE INVENTION

It is known to provide a window covering for an arched window. An example of such window coverings include those described in U.S. Pat. No. 5,794,680 entitled “Retractable Arched Window Covering” and U.S. Pat. No. 5,584,329 entitled “Moveable Shade For Palladian Windows”.

It is also known to provide a shutter for an arched window in which the louvers are arrayed radially about an arched window. Examples of such radially arranged shutters include those described in U.S. Pat. Nos. 5,537,780 and 6,341,447. Furthermore, U.S. Pat. No. 6,810,619 also illustrates an arched shutter having radially extending louvers or slats.

Also U.S. Pat. No. 4,671,035 disclosed a laminate and process for forming the same whereby a solid wood lamina is adhered to a corrugated laminate by conventional gluing techniques. The laminate is formed in manufacturing arcuate and other frames for windows and doors.

Furthermore U.S. Pat. No. 6,810,619 disclosed a shutter and frame system for reducing light passing through and around a shutter by incorporating a light blocking element along the sides of the louver to block light from passing between the shutter frame and the louvers. The shutter utilizes a louver which never extends beyond the plane of the rear face of the shutter frame.

Moreover U.S. Pat. No. 5,600,920 illustrates another arrangement.

Also U.S. Pat. No. 6,219,985 disclosed a louver and frame body assembly structure including an upper beam, a lower beam, two lateral columns, two side columns, several slats, and a linking bar with several pivotal nails.

Finally, U.S. Pat. No. 4,899,491 and U.S. Pat. No. 5,699,637 illustrates other arrangements.

It is an object of this invention to provide an improved shutter for an arched frame which is easy to construct and manufacture compared to the prior art.

It is an aspect of this invention to provide a covering for an arched window comprising at least one slat having two opposite ends connected to the arched window for pivotable rotational movement thereabouts.

It is another object of this invention to provide a shutter for an opening having a frame with two spaced substantially vertical members joined at their upper ends by an arched member; a plurality of arched horizontally disposed slats extending longitudinally between said members so as to present an upper and lower longitudinal edge terminating at two opposite ends disposed transversely between said longitudinal edges; said transverse ends shaped to correspond to the profile of said members; and pivoting structure disposed between each said frame member and said transverse end of said slats adjacent said lower longitudinal edge for pivotable rotational motion of said slats between and opened and closed position.

It is another aspect of this invention to provide a method of opening and closing an arched opening with a plurality of slats extending longitudinally and disposed between an arched frame defining the arched opening, said longitudinal stats defining two spaced longitudinal edges terminating to present two opposite ends disposed transversely between said longitudinal edges, said transverse ends shaped to correspond to said arched frame, comprising placing pivoting structure between said arched frame and each said transverse end adjacent said longitudinal edge; and moving said plurality of slats between an opened and closed position.

These and other objects and features of the invention shall now be described in relation to the following drawings;

### BRIEF DESCRIPTION OF DRAWINGS

FIG. 1 is a top plan view of one embodiment of the invention with the slats in a closed position.

FIG. 2 is a perspective view of the invention shown in FIG. 1 with the slats in an open position.

FIG. 3 is a partial perspective view illustrating the pivoting means.

FIG. 4 is a schematic view illustrating the forming of an arched section.

FIG. 5 is a perspective side elevational view of one embodiment of the frame.

FIG. 6 is a partial exploded view of FIG. 5.

FIG. 7 is a cross-sectional view of FIG. 5.

FIG. 8 is a perspective view of the invention showing the slats in an opened position with a second embodiment of the frame in a partial breakout view.

FIG. 9 is a top plan view of FIG. 8 but in a partially open position.

FIG. 10 is an exploded view of the second embodiment of the frame.

FIG. 11 is a cross-sectional view of FIG. 10 with the fastening means in place.

FIG. 12 is a perspective partially exploded view of a third embodiment of the frame.

FIG. 13 is a cross-sectional view of FIG. 12.

FIG. 14 is a cross-sectional view similar to FIG. 13 but showing the fastener in place.

FIGS. 15a, 15b, 15c, and 15d illustrate a fourth embodiment of the frame.

FIG. 16 illustrates a two part arched shutter.

### BEST MODE FOR CARRYING OUT THE INVENTION

In the description which follows, like parts are marked throughout the specification and the drawings with the same respective reference numerals. The drawings are not necessarily to scale and in some instances proportions may have been exaggerated in order to more clearly depict certain features of the invention.

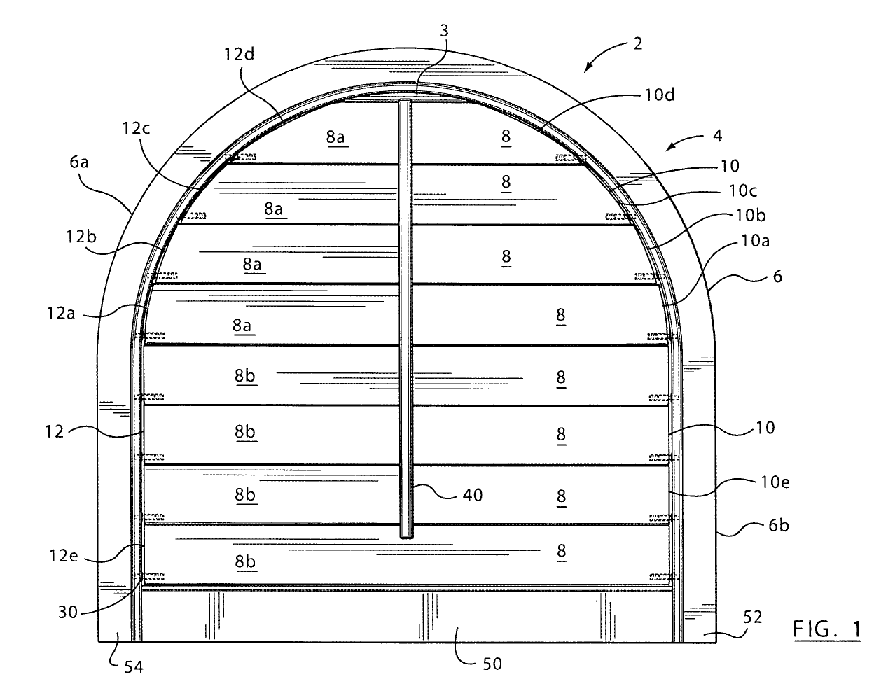

FIG. 1 illustrates a window covering 2 which generally comprises a shutter 4 for an opening such as a window or a door. The shutter 4 having a frame 6 and at least one slat 8 having two opposite ends 10 and 12 connected to the arched frame 6 for pivotable rotational movement thereabouts.

The frame 6 is comprised of an arched section 6a and a vertical section 6b.

The transverse ends 10 and 12 in the arched section 6a are curved to correspond to the arched section 6a. More particularly as shown in FIG. 1 the slats 8 that are presented in the arched section 6a define a first set of slats 8a which have transverse ends 10 and 12 that are cut or shaped to correspond to the shape of the curved arch in the arched section 12a. In other words, the transverse ends of the slats 8a present ends 10a, 10b, 10c, and 10d as well as transverse ends 12a, 12b, 12c, and 12d as can been seen from FIG. 1. The curved length of transverse ends 10a, 10b, 10c, 10d and 12a, 12b, 12c, and 12d become progressively longer and are shaped that so in the closed position the transverse ends are almost touching the arched frame section 6a so that in the closed position the arched opening is substantially closed. In other words any light from behind the louvers will be substantially blocked since there will be very little opening, if any, between the transverse ends 10 and 12 and the arched section 6a.

In the embodiment shown in FIG. 1 a small filler piece 3 is included although the upper must slat 8 could be shaped so that transverse ends 10 and 12 meet as a continuous curve next adjacent the frame 6a in the closed position.

Furthermore the shutter 4 also presents a second set of slats 8b which are disposed between the substantially vertically spaced frame members 6b as shown in FIG. 1. The transverse ends 10e and 12e of the second set of slats 8b are substantially straight or vertically aligned. As before, the space between the transverse ends 10e and 12e of the second set of slats 8b correspond to the profile of the vertical members 6b and in particular are very close so as to present a very small space between 10e and 12e and frame section 6b, if any.

Accordingly in the closed position as shown in FIG. 1 there is very light which passes between the slats and slats and frame.

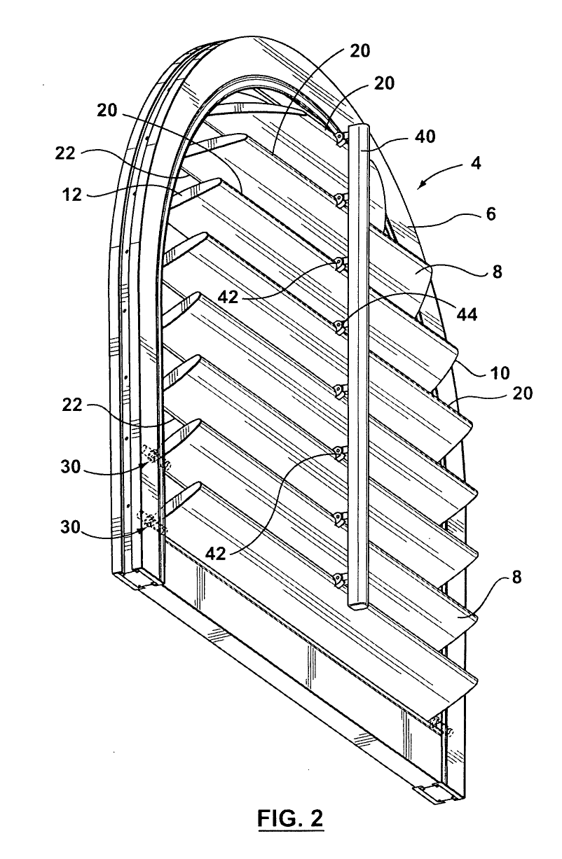

FIG. 2 illustrates the shutter 4 in an open position. As can be seen from FIGS. 1 and 2 each slat 8 extends longitudinally so as to present spaced longitudinal edges 20 and 22. In particular the longitudinal edges 20 and 22 present an upper longitudinal edge 20 and lower longitudinal edge 22.

The slats 8 are substantially horizontally disposed relative to the frame 6 and extend longitudinally between the frame so as to present the upper 20 longitudinal edge and lower 22 longitudinal edge terminating at two opposite ends 10 and 12 disposed transversely along longitudinal edges 20 and 22.

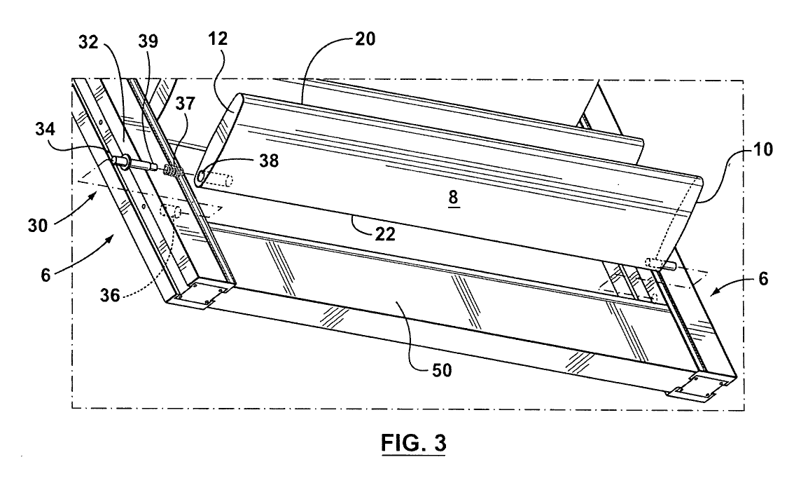

Pivoting means 30 are disposed between each said frame member 6 and transverse ends 10 and 12 adjacent the lower longitudinal edge 22 for pivotable rotational motion of the slats 8 between the opened and closed positions as shown in FIG. 1, FIG. 2 and FIG. 3. The shutter 4 also includes a control rod 40 which is pivotally connected to the upper longitudinal edge 20 of each of the slats 8 as shown in FIG. 2. The control rod 40 is operable within the room (not shown). The control rod 40 is connected to the upper longitudinal edge 20 about a pivotable connecting means 42 which is pivotally connected to an extension 44 extending from the control rod 40. Accordingly upon manipulation of the control rod 40 the slats 8 as shown in FIG. 1 may be moved from the closed position in FIG. 1 to the open position in FIG. 2 by pulling down on the control rod as shown in FIG. 1 to the position shown in FIG. 2.

The pivoting means as illustrated in FIG. 3 comprises a pin 32 having one end 34 adapted to be received in a hole 36 disposed in the frame 6. The transverse ends 10 and 12 also include a hole 38 which is adapted to receive another end 39 of the pin 32. A spring 37 may be utilized so as to provide a resistance means to keep the slats 8 open in a preselected position as can be seen from FIG. 3. The hole 38 is disposed in the transverse ends 12 and 10 in the region adjacent the lower longitudinal edge 22 of the slat 8. Alternatively the hole 38 could be disposed in the transverse ends 12 and 10 in the region adjacent the upper horizontal edge 22 of slat 8.

By positioning the pivoting means 30 in the region adjacent the lower transverse edges 10 and 12 adjacent the lower longitudinal edge 22 one can shape the transverse edges 10 and 12 so as to but up almost against the arched shape as shown in FIG. 1. Furthermore upon opening of the slats 8 in the arched section 6a the edges of the transverse ends 10 and 12 do not catch the arched frame as the slats are moved from the opened to closed position.

As can be seen from FIG. 1 the shutter also includes a horizontal member 50 extending between the opposed ends 52 and 54 of the frame 6 as shown.

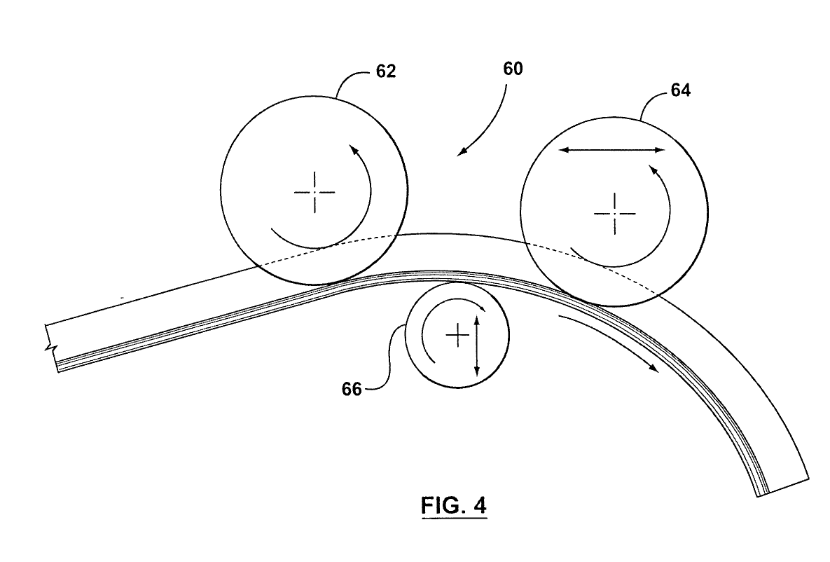

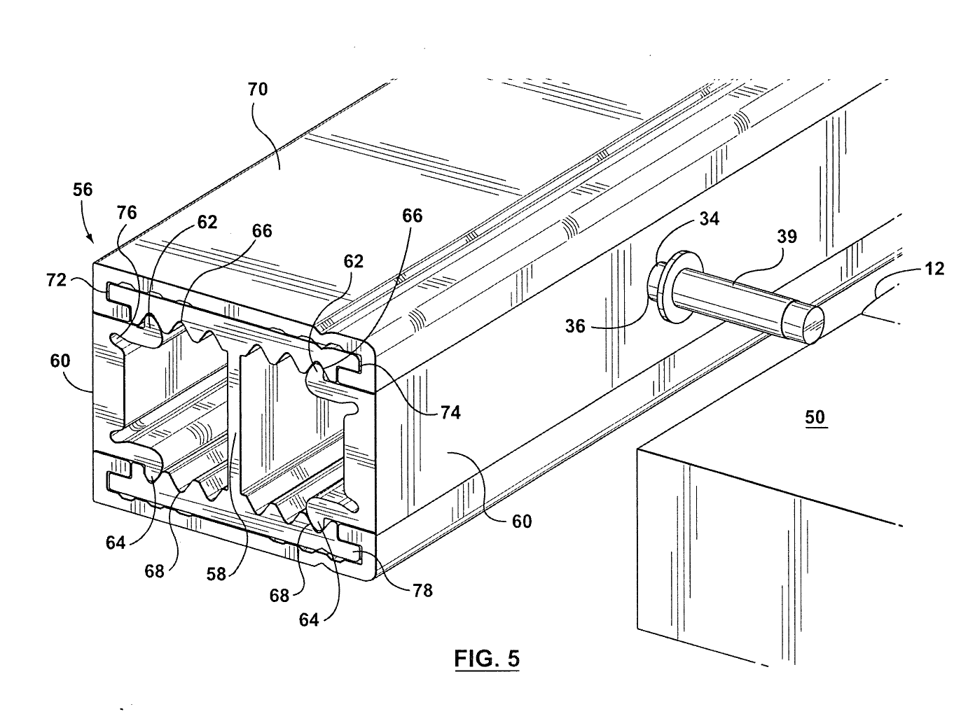

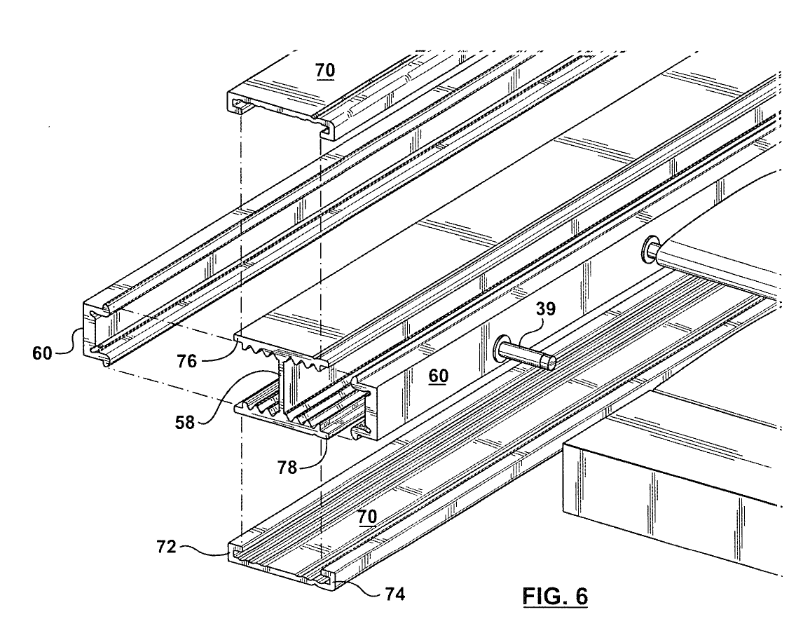

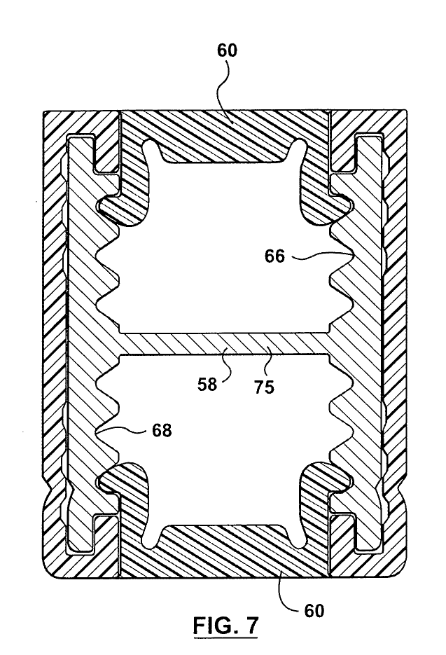

FIGS. 5, 6 and 7 illustrate one embodiment of the frame assembly 56 which comprises the frame 6 as shown in FIG. 1. In particular the frame assembly 56 can comprise of an extruded piece 58 having a “H-shaped” cross-section as shown. In one embodiment the extruded member 58 comprises of an aluminium extrusion which starts out as a straight piece and then bent in a forming means 60 as shown in FIG. 4.

The forming means in one embodiment can comprise of rollers 62, 64 and 66 which can be rotated as shown so as to bend an extruded member such as the H-shaped extruded member 58 as shown to form the shape as shown in FIG. 1. In particular the extruded aluminium member 58 will have two spaced substantially parallel extensions 6b which are joined together by an arched section 6a. Thereafter the bottom piece 50 can be connected as shown in FIG. 1. The frame assembly 56 also includes side member 60 which include two upstanding projections 62 which are adapted to be received within one of the recesses 66 and 68 presented by the extruded member 58. The side members 60 can be comprised of a variety of materials including metal such as aluminium or the like as well as flexible plastic. In particular the side members 60 can comprise of flexible plastic that can be slid or snapped into place into the extruded member so as to define a smooth inner surface 60 of the frame 6. Inner surface 60 is disposed facing slats 8 having vertical transverse ends 10 and 12 as well as the slats having curved transverse ends 10 and 12 in the arched section 6a. Accordingly a simple method of producing a continuous frame between the vertically extending slat members 8 and the arcuate transverse ends 10 and 12 in the arched section 6a can be produced. Furthermore a smooth finished surface or liner 70 can be snapped into place as shown. In particular the liner 70 includes two spaced apart recesses 72 and 74 which are adapted to receive the outer ends 76 and 78 of the H-shaped extruded member 58.

The liner 70 can be comprised of a variety of materials including a flexible plastic or vinyl so as to produce a smooth finished face. The side members 60 can include a plurality of holes 36 to accommodate the pivoting means 30 as previously described.

The “hollow” frame assembly 56 produces a light weight frame 6 which is easy to construct and assemble.

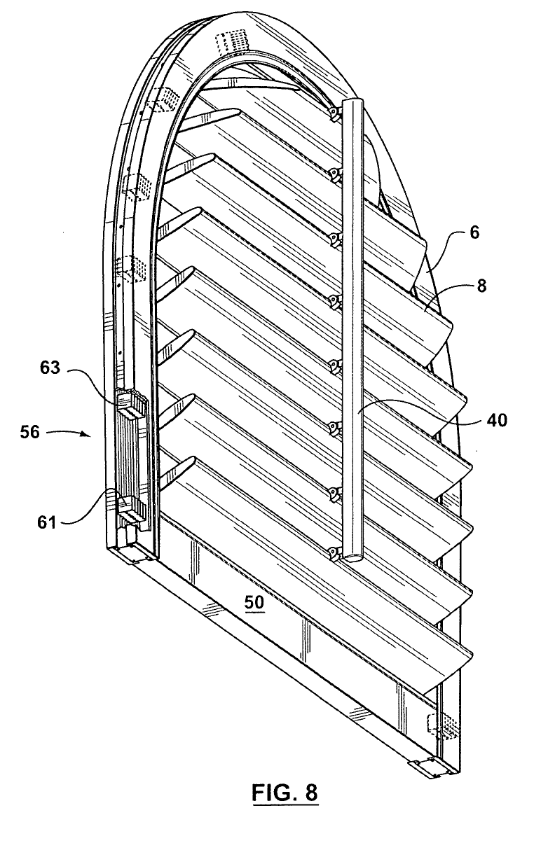

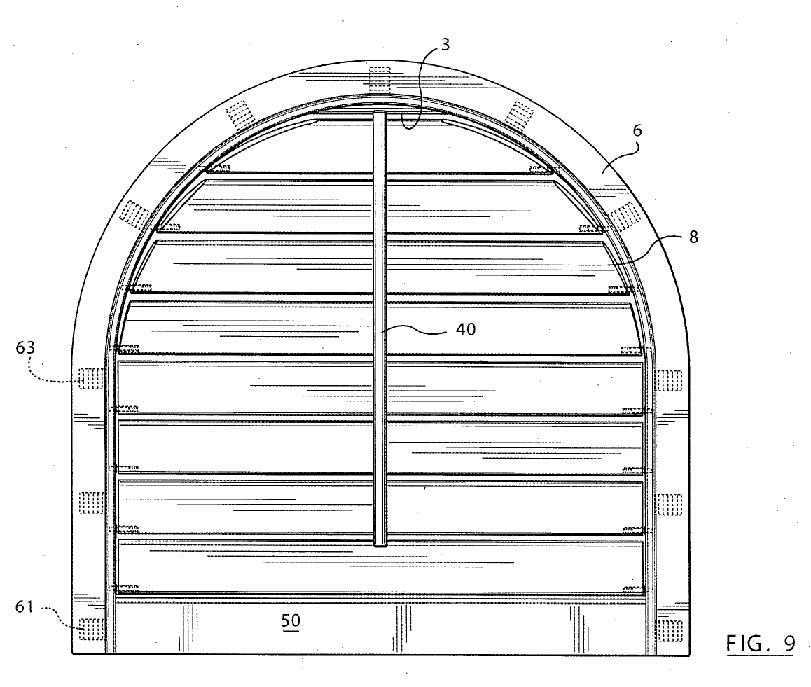

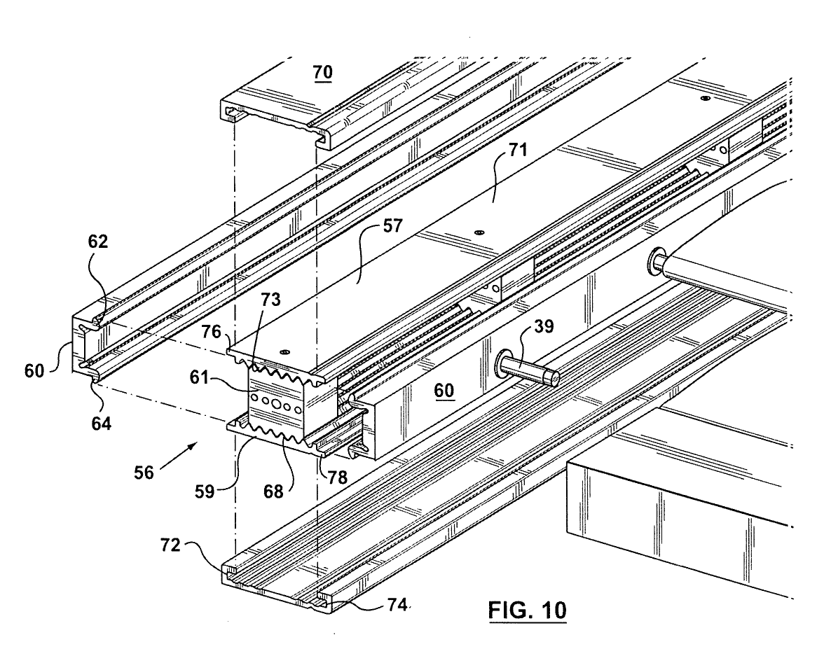

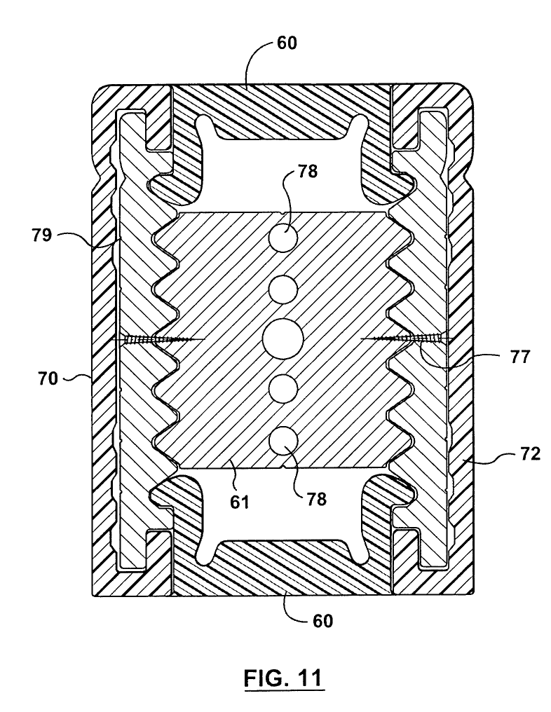

FIGS. 8, 9, 10 and 11 illustrate a further embodiment of the frame assembly 56 which comprises instead of the H-shaped extruded section 58 as shown in FIG. 5, two spaced substantially flat extruded members 57 and 59 connected together by a plurality of filler pieces 61. The two substantially flat extruded members 57 and 59 have an outer surface 71 which is substantially smooth and an inner surface 73 which presents a plurality of zigzag recesses 73. The filler piece 61 also includes corresponding engaging surface 63 to engage surface 73. The filler piece 61 takes the place of the web 75 of the H-shaped extruded member 58. The extruded substantially flat members 57 and 59 can be formed in a forming machine similar to that shown in FIG. 4 so as to present the arched profile as previously described.

Moreover the zigzag shape of side 73 of flat extruded members 57 and 59 as well as the zigzag shape of the H-cross-section 58 facilitates the bending of the members into an arched shaped.

A second embodiment of the frame assembly 56 once assembled can be locked into place by utilizing fasteners such as screws 77. The extruded substantially flat members include a plurality of notches 79 to permit easy location of the fasteners 77 to be driven through the extruded members 57 and 59 as shown. The filler piece 61 can include a plurality of holes 78 to lighten the assembly.

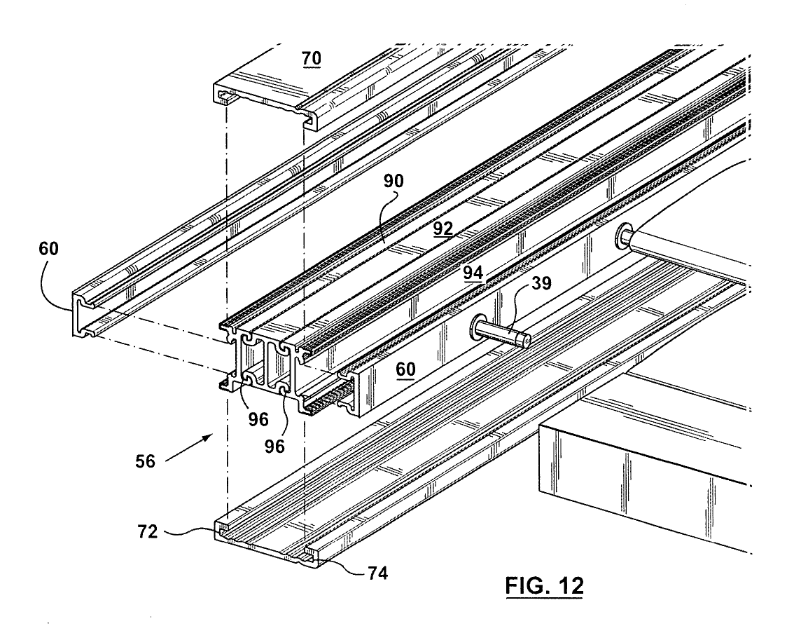

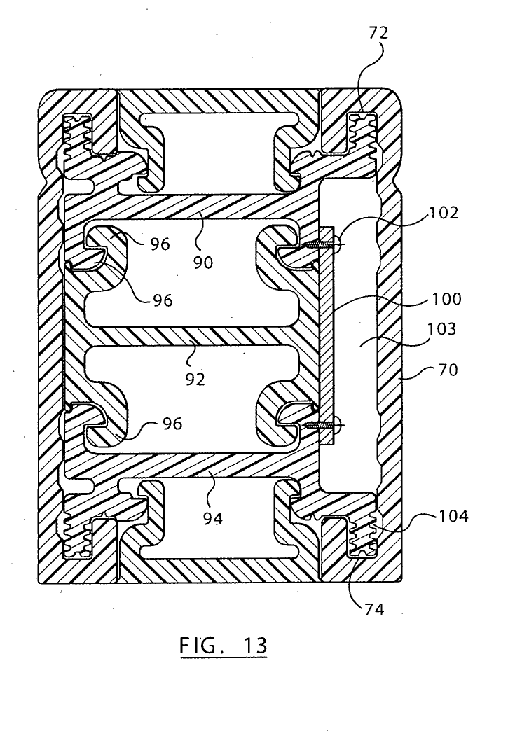

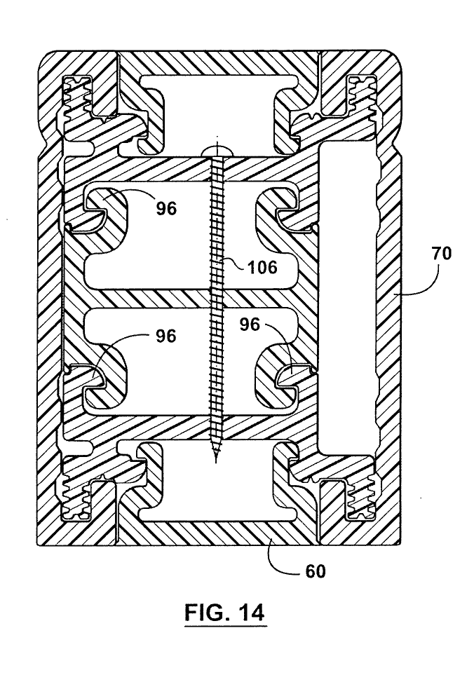

FIGS. 12, 13 and 14 illustrate a third embodiment of the frame assembly 56 which comprises of a plurality of sliding members 90, 92 and 94 having a plurality of interlocking tabs or fingers 96. In particular the members 90, 92 and 94 can comprise of aluminium extrusion which is formed as shown in FIG. 4 to the desired arch profile. The extruded members 90, 92 and 94 slide relative one another.

In an alternate arrangement the extruded members 90, 92 and 94 can comprise of flexible material such as plastic or vinyl or the like and locked into place by means of locking plates 100 and screws 102 which are adapted to be secured within the sliding members as shown.

The securing plates 100 are disposed in a recess 103 disposed to one side of the assembly 56. Sliding members 90 and 94 including projections 104 which are slotted as shown and adapted to be received within recesses 72 and 74 of finishing member 70.

Alternatively instead of utilizing locking plate 100 and screw 102 a fastener 106 can be disposed as shown to lock the members to the desired shape.

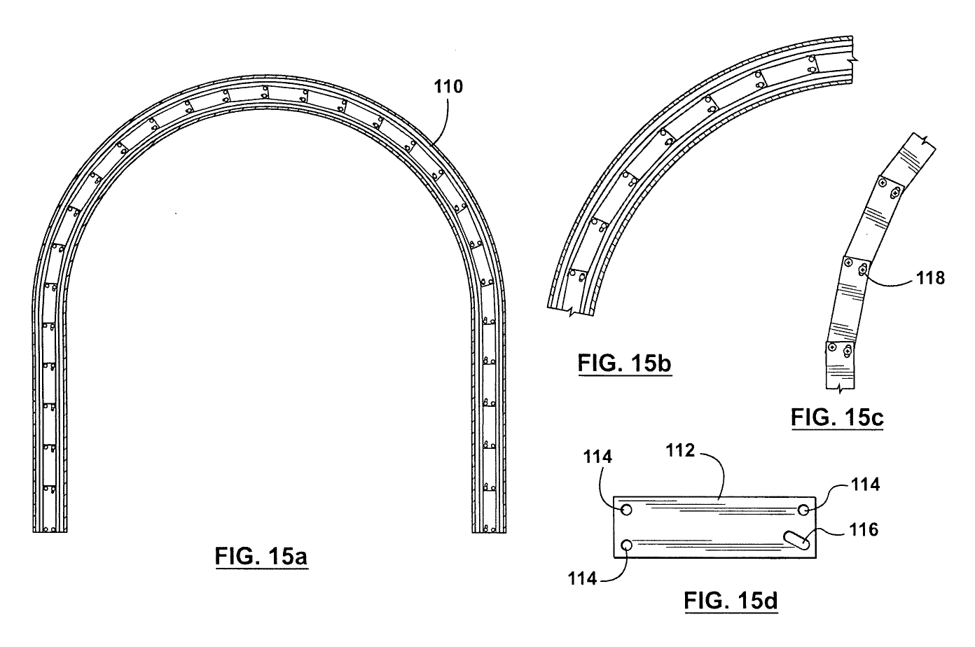

FIGS. 15a, 15b, 15c and 15d illustrate yet another embodiment of the frame assembly which comprises of a plurality of sliding members 104 which are shaped to the desired arch shape and locked into place by means of locking plates 112 having a plurality of holes 114 adapted to receive screws 118. Furthermore one of the holes may be comprised as a slot so as so angle successive locking plates 15 as illustrated in FIGS. 15a, 15b, 15c and 15d.

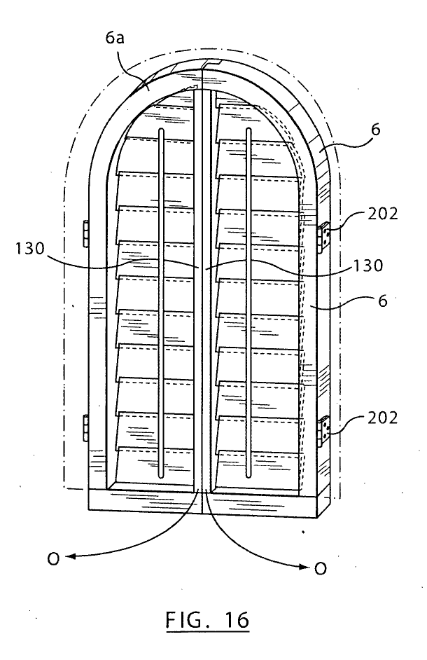

FIG. 16 illustrates another embodiment of the invention where the shutter comprises tow parts having vertical extensions 130 to permit the shutter to swing about hinges 202 in the direction of arrow O.

The arrangement shown in FIGS. 15a, 15b, 15c and 15d can be utilized where the slideable members 110 are comprised of a soft material such as vinyl or the like.

The invention described above relates to a method of opening and closing an arched opening with a plurality of a first set of slats extending longitudinally and disposed between an arched frame defining said arched opening, said longitudinal slats defining two spaced longitudinal edges terminating to present two opposite ends disposed transversely between said longitudinal edges comprising placing pivoting means between said arched frame and each said transverse ends adjacent said longitudinal edges; moving said plurality of said first set of slats between an opened and closed position.

Further the invention described above relates to a method wherein said arched frame extends outwardly to present two spaced substantially parallel frames, and having a second set of slats disposed substantially parallel to said first set of slats, said first and second set of slats moving in unison with said first set of slats between said opened and closed positions.

Various embodiments of the invention have now been described in detail. Since changes in and/or additions to the above-described best mode may be made without departing from the nature, spirit or scope of the invention, the invention is not to be limited to said details.

I claim:

1. A covering formed for an arched window comprising at least one slat having two opposite ends connected to said arched window for pivotable rotational movement thereabouts.

2. A covering as claimed in claim 1 wherein said ends are curved to correspond to said arched window.

3. A covering as claimed in claim 2 wherein said slat extends longitudinally between said arched window so as to present two spaced longitudinal edges and each said ends disposed transversely between said longitudinal edges.

4. A covering as claimed in claim 3 further including an arched frame, and pivoting means extending between each said transverse end and said arched frame.

5. A covering as claimed in claim 4 wherein said pivoting means comprises a pin disposed in a hole presented by said frame and a hole presented by each said transverse end of said slat.

6. A covering as claimed in claim 5 wherein said transverse hole is disposed adjacent one of said longitudinal edges.

7. A covering as claimed in claim 6 wherein one of said longitudinal edges is longer than said other longitudinal edge and said transverse hole is disposed adjacent said longer longitudinal edge.

8. A covering as claimed in claim 7 wherein said frame is comprised of a plurality of sliding members for slideable relative movement therebetween so as to form an arch corresponding to said arched window and lockable in said arched position.

9. A covering as claimed in claim 8 wherein said frame includes a finished covering for said frame.

10. A shutter for an opening comprising:
(a) a frame having two spaced substantially vertical members joined at their upper ends by an arched member;
(b) a plurality of substantially horizontally disposed slats extending longitudinally between said members so as to present an upper and lower longitudinal edge terminating at two opposite ends disposed transversely between said longitudinal edges;
(c) said transverse ends shaped to correspond to the profile of said members;
(d) pivoting means disposed between each said frame member and said transverse end of each said slot adjacent said lower longitudinal edge for pivotable rotational motion of said slats between an opened and closed position.

11. A shutter as claimed in claim 10 further including a control rod connected to each said slat for substantial simultaneous movement of each said slat between said closed and opened positions.

12. A shutter as claimed in claim 11 wherein said slats define a first set of slats adjacent said vertical members having substantially vertical transverse ends.

13. A shutter as claimed in claim 12 wherein said slats define a second set of slats having at least one transverse end adjacent said arched member, said at least one transverse ends having curved transverse ends corresponding to said profile of said arched member.

14. A shutter as claimed in claim 13 wherein said second transverse end of said slats adjacent said vertical member have a substantially vertical profile.

15. A shutter as claimed in claim 13 wherein said second traverse end is adjacent said arched member and having a curved transverse end corresponding to said profile of said arched member.

16. A shutter as claimed in claim 13 wherein said first set of slats and said second set of slats move in unison.

17. A shutter as claimed in claim 16 wherein said opening is a window or a door.

18. A shutter as claimed in claim 17 wherein said frame is hinged to said window and said arched member comprises of two swingable parts.

19. A method of opening and closing an arched opening with a plurality of a first set of slats extending longitudinally and disposed between an arched frame defining said arched opening, said longitudinal slats defining two spaced longitudinal edges terminating to present two opposite ends disposed transversely between said longitudinal edges comprising:
(a) placing pivoting means between said arched frame and each said transverse ends adjacent said longitudinal edges;
(b) moving said plurality of said first set of slats between an opened and closed position.

20. A method as claimed in claim 19 wherein said arched frame extends outwardly to present two spaced substantially parallel frames, and having a second set of slats disposed substantially parallel to said first set of slats, said first and second set of slats moving in unison with said first set of slats between said opened and closed positions.

21. An arched frame having a plurality of inner engageable sliding members bent to define an arched shape, including fastening means to hold said members in said arch, with at least one continuous exterior arch member defining said arched shape.

22. An arched shaped frame as claimed in claim 21 wherein said at least one continuous exterior arch member extends outwardly to present two spaced substantially parallel members.
